(19) United States
(12) Patent Application Publication
(10) Pub. No.: US 2024/0209654 A1
(43) Pub. Date: Jun. 27, 2024

(54) ANIMAL ENCLOSURE FRONT GATE

(71) Applicant: L.T. HAMPEL CORP., Germantown, WI (US)

(72) Inventor: Lance T. Hampel, Germantown, WI (US)

(21) Appl. No.: 18/554,155

(22) PCT Filed: Apr. 6, 2022
(86) PCT No.: PCT/US2022/023713

§ 371 Date: Oct. 5, 2023

Related U.S. Application Data
(60) Provisional application No. 63/171,545, filed on Apr. 6, 2021.

(51) Int. Cl. E05B 63/00; E05B 15/00; E05B 65/00; E05C 19/08

(52) U.S. Cl. CPC E05B 63/0052; E05B 15/0093; E05B 65/0007; E05C 19/08

(57) ABSTRACT

A bar latch including a top portion including and inner and outer surface, a latch retaining aperture disposed in a fore end of the top portion and extending between the inner and outer surface, a first side portion connected to the top portion at a first angle relative to the top portion, where the first side portion includes a first arm extending beyond an aft end of the top portion, and a second side portion connected to the top portion at a second angle relative to the top portion and substantially equal but opposite to the first angle, where the second side portion includes a second arm that extends beyond the aft end of the top portion, wherein an inner surface of the first side portion, an inner surface of the second side portion, and the inner surface of the top portion collectively form a channel extending along the inner surface of the top portion, and wherein the bar latch is configured to be rotatably coupled to a door frame, the bar latch rotatable relative to the door frame between an open and a closed position.

### CROSS-REFERENCE TO RELATED APPLICATIONS

This application claims priority to U.S. Provisional Patent Application No. 63/171,545, filed Apr. 6, 2021, the entire contents of all of which are hereby incorporated by reference.

### FIELD OF THE INVENTION

The present invention relates to housing units for animals.

### BACKGROUND

Farm animals often live in housing units that provide shelter and a space for the animal to move around. For example, calves may live in individual housing units with shelters (e.g., hutches) and with fences surrounding a yard in front of the hutch. The calves may roam between the hutch and the yard.

### SUMMARY

In at least one embodiment, the present disclosure provides, a bar latch including a top portion including and inner and outer surface, a latch retaining aperture disposed in a fore end of the top portion and extending between the inner and outer surface, a first side portion connected to the top portion at a first angle relative to the top portion, where the first side portion includes a first arm extending beyond an aft end of the top portion, and a second side portion connected to the top portion at a second angle relative to the top portion and substantially equal but opposite to the first angle, where the second side portion includes a second arm that extends beyond the aft end of the top portion, wherein an inner surface of the first side portion, an inner surface of the second side portion, and the inner surface of the top portion collectively form a channel extending along the inner surface of the top portion, and wherein the bar latch is configured to be rotatably coupled to a door frame, the bar latch rotatable relative to the door frame between an open and a closed position.

In at least another embodiment, the present disclosure provides a gate and latch assembly including a door frame including dual top horizontal wires, a bottom edge, a first outermost vertical wire, a second outermost vertical wire opposite the first vertical wire, a first side threshold wire, a second side threshold wire, and a bottom threshold wire. A door is disposed between the first side threshold wire and the second side threshold wire, and above the bottom threshold wire, where the door has one or more hinge hooks extending from a vertical wire of the door and engaging the first side threshold of the door frame. A bar latch is rotatably supported on one of the dual top horizontal wires.

In at least another embodiment, the present disclosure provides a bidirectional gravity latch assembly including a mounting plate comprising a back portion including at least one fastener hole and a side portion connected to the back portion at an angle relative to the back portion, a latch bolt retaining portion connected to the back portion and adjacent to the side portion, the latch bolt retaining portion including a hinge-pin through-hole, a latch bolt seat portion disposed below the latch bolt retaining portion, a latch bolt disposed in the latch bolt retaining portion and including a hinging portion having a hinge-pin through-hole, a seat abutting portion, and a lever portion, and a hinge pin disposed in both the hinge-pin through-hole of the latch bolt retaining portion and the hinge-pin through-hole of the latch bolt, such that the latch bolt is rotatably retained in the latch bolt retaining portion and is movable between an open and closed position. a bar latch comprises: a top portion including an inner and outer surface, and a retaining member aperture disposed in the fore end of the top portion.

Other aspects of the invention will become apparent by consideration of the detailed description and accompanying drawings.

### BRIEF DESCRIPTION OF THE DRAWINGS

FIG. 1 is a perspective view of a housing system according to one embodiment with a perimeter fence including a wire door and wire door frame assembly connected to wire side panels, the wire door held closed by a bar latch.

FIG. 2 is a perspective view of the closed wire door and wire door frame assembly of FIG. 1 excluding the bar latch and side panels.

FIG. 3 is a perspective view of the wire door and wire door frame assembly of FIG. 2 with the wire door in a lifted and opened position.

FIG. 4 is a perspective view of the bar latch of FIG. 1 in an open position.

FIG. 5 is a perspective view of the bar latch of FIG. 4 in a closed position, retained in place by a retention device.

FIG. 6 is a top view of the wire door frame and bar latch of FIG. 1.

FIG. 7 illustrates the perimeter fence of the housing system in a transport configuration, the perimeter fence comprising a wire door frame with wire door, assembled with side panels.

FIG. 8 is a perspective view of a heavy duty door and heavy duty door frame.

FIG. 9 is a perspective view of the heavy duty door in an opened position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

Farm animals often live in housing units that provide shelter and a space for the animal to move around. For example, calves may live in individual housing units with shelters (e.g., hutches) and with fences surrounding a yard in front of the hutch. The calves may roam between the hutch and the yard. At times it may be beneficial for a person to enter the yard to assist the animals, provide food, clean, etc. Accordingly, disclosed herein is a fence door assembly including a door frame and door for providing access to the yard. The present disclosure is filed alongside a related application stemming from U.S. Provisional Patent Application No. 63/171,528, filed Apr. 6, 2021, the entire contexts of which is hereby incorporated by reference.

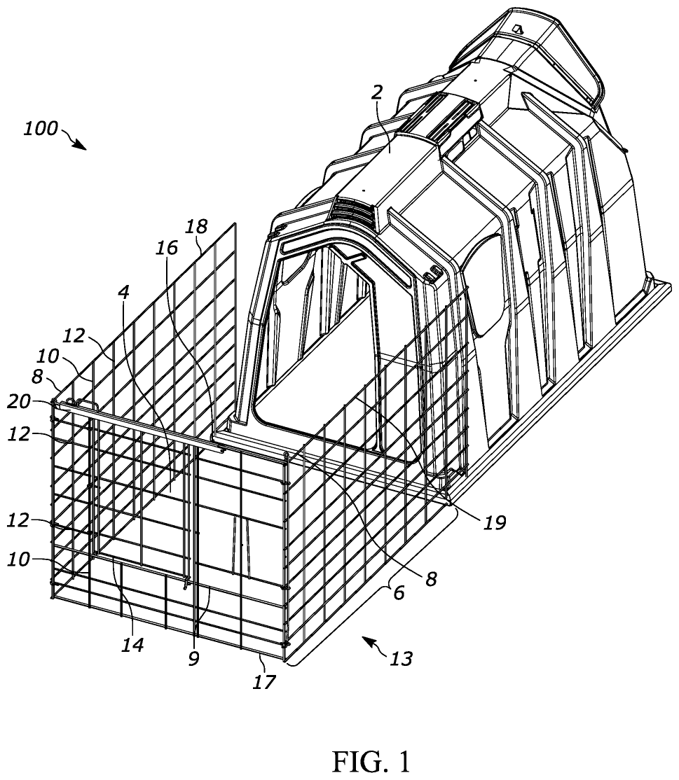

FIG. 1 illustrates an embodiment of an animal housing system 100. The animal housing system 100 includes a hutch 2, and a yard 4 enclosed by a perimeter fence 6. The perimeter fence 6 includes two side panels 8 and front gate 13 extending between the two side panes 8 to form a U-shape. The front gate 13 includes a door 14 and door frame 9 assembly supporting the door 14. One or both of the door 14 and the door frame 9 may be formed of wire. For example, in the illustrated embodiment, the side panels 8 and the door frame 9 comprise a number of vertical wires 10 and horizontal wires 12 positioned in a mesh pattern and welded together to form a fence. The horizontal wires 12 of both the door frame 9 and the side panels 8 may be positioned closer together near the bottoms of both the door frame 9 and the side panels 8, as compared to near the tops of both the door frame 9 and side panels 8, to prevent small animals from passing any part of their body through the mesh formed by the horizontal wires 12 and vertical wires 10 of the side panels 8 and door frame 9. For example, the vertical spacing of the horizontal wires 12 of the door frame 9 and the side panels 8 may be 6 inches on the top halves of each of the door frame 9 and the side panels 8, while the vertical spacing of the horizontal wires 12 of the door frame 9 and the side panels 8 may be 2 or 3 inches on the bottom halves.

When the door 14 is in a closed position, the door 14 and door frame 9 together define and lie within a vertical plane running through both a bottom horizontal wire 17 of the door frame 9 and a top horizontal wire 15 of the wire door 14. Similarly, each side panel 8 defines and lies within a vertical plane defined by a top horizontal wire 18 of the side panel 8 and a bottom horizontal wire 16 of the side panel 8. The door frame 9 is connected to the two side panels, which meet the edges of the door frame 9 at an angle perpendicular to the vertical plane defined by the door 14 and door frame 9. In the embodiment shown, the front gate 13 is releasable coupled to the two side panels 8. This enables the front gate 13 and/or the side panels 8 to be selectively removed or replaced.

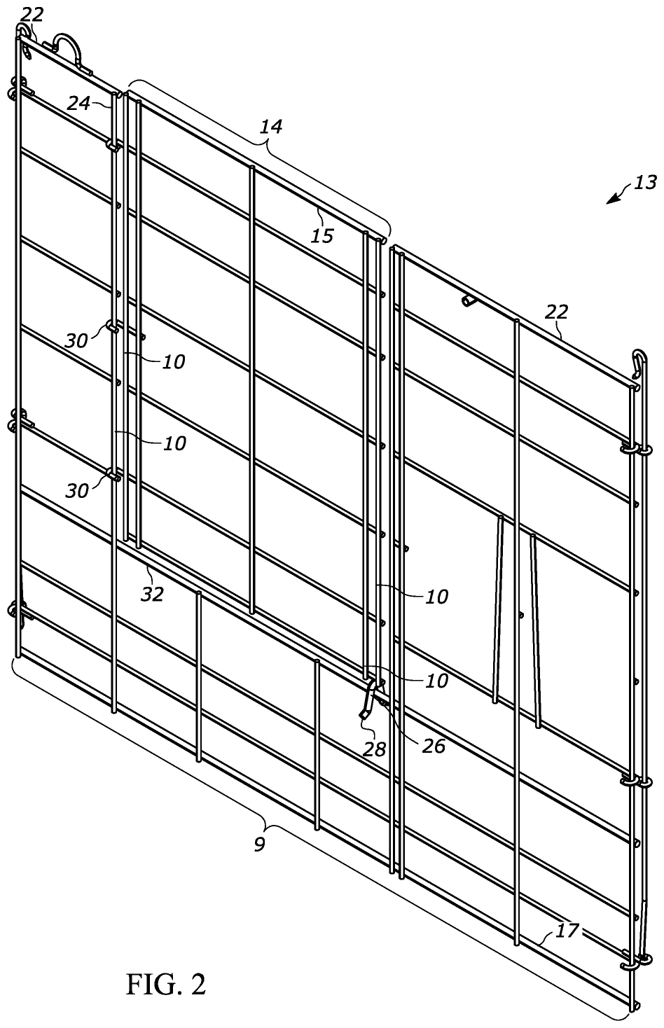

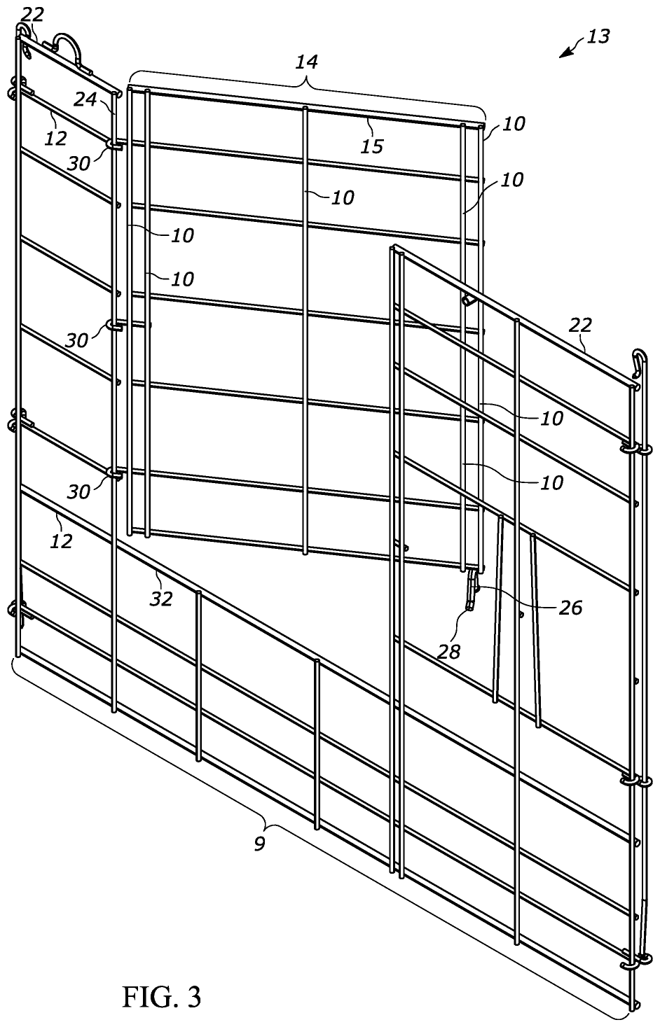

FIGS. 2-3 illustrate an opening and closing motion of the door 14. FIG. 2 shows the door 14 is in a closed position and aligned with the vertical plane defined by the door frame 9. At the lateral extremities of the door 14, an extra set of vertical wires 10 reinforce the door by preventing flexion. Hinge hooks 30 positioned along one of the lateral extremities of the door rotatably connect the door 14 to the door frame 9. In particular, the hinge hooks 30 grip (or wrap around) a side threshold wire 24 of the door frame 9. The door 14 further includes a door foot 26, which rests on a bottom threshold wire 32 of the door frame 9 when the door 14 is in the closed position. The door foot 26 may prop up or support the door 14 above the bottom threshold wire 32 to maintain the levelness of the door 14 and prevent sagging or tilting of the door 14 relative to the door frame 9. In the example shown, the door foot 26 resembles an upside-down U-shape, which includes two toes 28 that saddle the bottom threshold wire 32 of the door 14 when the door 14 is closed. The toes 28 of the door foot 26 also help brace the bottom of the door 14 in parallel alignment with the threshold when the door 14 is in the close position.

FIG. 3 illustrates the door 14 is in an opened position such that the door 14 is no longer aligned with the vertical plane defined by the door frame 9. To open the door 14, a person may lift the door 14 and rotate it about a hinge formed by the hinge hooks 30 and the side threshold wire 24. When the door 14 is lifted, the door foot 26 lifts off of the bottom threshold wire 32 and the hinge hooks 30 slide vertically along the side threshold wire 24 toward the dual top horizontal wires 22 of the door frame 9. Lifting the door 14 also releases the door foot 26 from engaging the bottom threshold wire 32 of the door frame 9.

When the door 14 is lowered after being lifted, at least some of the hinge hooks 30 may rest on horizontal wires 12 of the door frame, thus preventing the hinge hooks 30 from sliding down the side threshold wire 24 of the door frame 9. To close the door 14, the opening procedure may be performed in reverse. Specifically, the door 14 may be lifted and rotated until it becomes flush with the door frame 9. The closed door 14 and door frame 9 define a secured yard 4 for an animal to roam in, while optionally providing a person access to the yard 4 by way of the door 14. In some embodiments, rotation of the door may be limited by a door stop (not shown) fixed to a side threshold wire 24, a bottom threshold wire 32, a side threshold bar (not shown), or a bottom threshold bar (not shown) of the door frame 9.

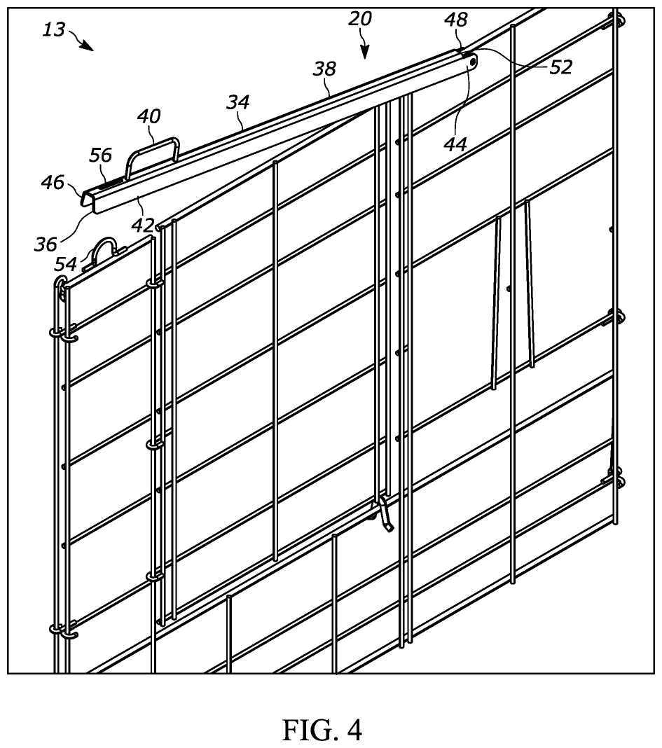

Referring to FIGS. 4-6, the door 14 may be held closed by a bar latch 20 when the door 14 is in the closed position. Furthermore, the bar latch 20 may provide stability and strength to the front gate 13 by adding rigidity across the front gate 13 when the wire door 14 is closed. In particular, the bar latch 20 creates a rigid closure between the door 14 and the door frame 9 and reduces movement and shifting between the door 14 and the door frame 9 when the wire door 14 is closed. Accordingly, the bar latch 20 may be used to lock door 14 in a closed position while also bracing the top horizontal wires 22 of the door frame 9 and the top horizontal wire 15 of the wire door 14 so that they react to incident forces as a monolith. Additionally, a bar latch hinge device 32 is disposed on one of the dual top horizontal wires 22 of the door frame 9, and acts as an anchor for the bar latch 20 and rotation axis for a bar latch 20. A retaining member 54 is disposed on the other of the dual top horizontal wires 22 of the door frame 9 to lock the bar latch 20 in a locked position.

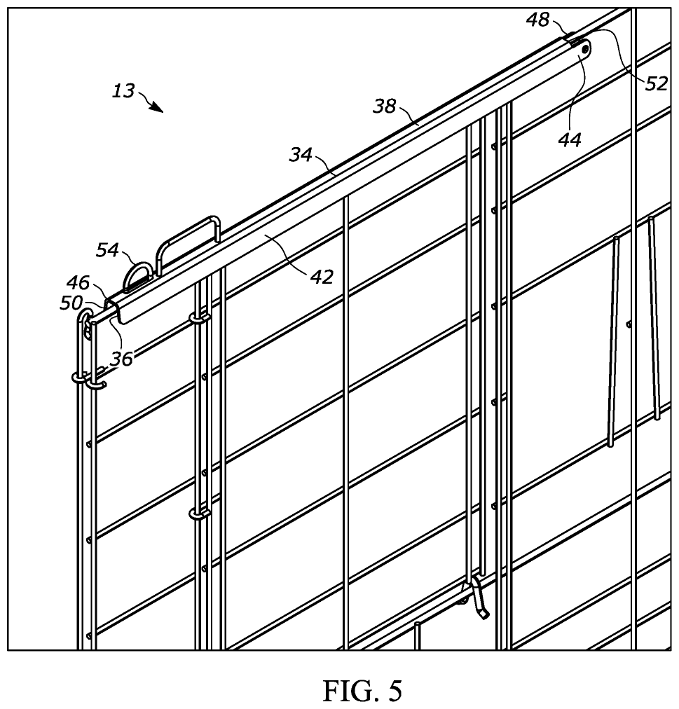

FIGS. 4-5 illustrate an opening and closing motion of the bar latch 20. The illustrated bar latch 20 is a generally U-shaped bar that partially surrounds the dual top horizontal wires 22 of the door frame 9 and the top horizontal wire 15 of the wire door 14. The bar latch 20 comprises a top portion 34 and two opposed side portions 42 and 46 extending downward from the top portion 34. Specifically, the bar latch 20 comprises a top portion 34 including and inner surface 36 and outer surface 38. The bar latch 20 includes an aperture 56 disposed in the fore end of the top portion 34 and extending through the inner surface 36 and outer surface 38. A handle 40 extends from the outer surface 38 of the top portion 34. A first side portion 42 of the bar latch 20 extends from the top portion 34 at an angle (for example, a right angle) relative to the top portion 34, and includes an arm 44 that extends beyond an aft end of the top portion 34. A second side portion 46 is connected to the top portion 34 at an angle relative to the top portion 34 and substantially equal but opposite to the angle of the first side portion 42. The second side portion 46 also includes an arm 48 that extends beyond the aft end of the top portion 34. The top portion 24 and the two side portions 42 and 46 collectively form a channel. The channel is configured to sit atop and engage both of the dual top horizontal wires 22 of the door frame 9 when the latch is in the closed position.

As will be described in further detail below, the extension of the arms 44 and 48 beyond the aft end of the top portion forms a hinge movement window 52, which both enables rotation of the bar latch 20 and limits rotation of the bar latch 20. Specifically, the hinge movement window 52 enables rotation of the bar latch 20 by providing an open space for the top horizontal wire 22 so that the aft end of the bar latch does not collide with at least one of the dual top horizontal wires 22 when the bar latch 20 rotates towards an open position. However, after a certain amount of rotation towards the open position, aft end of the top portion 34 the bar latch 20 will meet one of the dual top horizontal wires 22 and prevent further rotation of the bar latch 20. In this way, the bar latch 20 is enabled by the hinge movement window to rotate from a parallel angle with respect to the door frame 9 to an obtuse angle with respect to the door frame 9. This obtuse angle may be between 91 degrees and 180 degrees with respect to the door frame, and may be directly related to the length of the hinge movement window.

In the embodiment shown in FIGS. 4-5, the bar latch 20 is rotatably coupled to the door frame by the bar latch hinge device 32, which is disposed on one of the dual top horizontal wires 22 of the door frame 9. In some cases, the bar latch 20 has some elasticity (or “give”) and is therefore capable of being clipped down onto the bar latch hinge device 32 over one of the dual top horizontal wires 22 of the door frame 9. In other embodiments, the bar latch 20 is rigid and is engaged to the hinge device by a pin or fastener (e.g., a bolt) through a pinhole in the side portions 42 and 46 of the bar latch 20. The handle 40 disposed on the bar latch 20 helps an operator of the door 14 grab the bar latch 20 and rotate it out of the way of the door 14 towards an unlocked position, as shown in FIG. 4, so that the door 14 and door frame 9 are not braced into a monolithic arrangement by the bar latch 20. When the door 14 is closed, the bar latch 20 can be rotated into a closed (i.e., the locked) position, as shown in FIG. 5, thereby bracing the door 14 and door frame 9 into an arrangement wherein the door 14 and door frame 9 react to lateral forces as a monolith.

The aperture 56 is disposed at a fore end of the bar latch 20 opposite the end of the bar latch 20 which is rotatably coupled to the door frame 9 by the bar latch hinge device 32. When the bar latch 20 is rotated to a closed position, the aperture 56 engages a retaining member 54 disposed on the dual to horizontal wire 22 of the door frame 9 opposite one of the dual top horizontal wire 22 on which the bar latch hinge device 32 is disposed. In the illustrated embodiment, the retaining member 54 extends through the aperture 56 to lock the door 14. For example, when the bar latch 20 closes, the retaining member 54 is “snap fit” into the aperture 56 to maintain the bar latch 20 in a closed and locked position.

The illustrated retaining member 54 is a bent, hemispherical wire that is fixed at one end to one of the dual top horizontal wires 22 of the door frame 9, while the other end of the retaining member 54 is not fixed to anything. In the embodiment shown in FIG. 5, the hemispherical shape of the retaining member 54, combined with the fact that it is only fixed on one end, causes it to elastically deform when the aperture 56 squeezes down over it as the bar latch 20 is closed. The lateral force of the retaining member 54 attempting to return to its un-squeezed shape acts as a retention force on the aperture 46 and in turn the bar latch 20. Therefore, force is required to overcome the retention force of the latching retaining device when the bar latch 20 is once again opened. It is contemplated that the retaining member 54 may take on other shapes and forms, such as a clip that engages the bar latch 20. It is also contemplated that, in some cases, the bar latch 20 may not comprise a aperture 56, and in some cases may comprise a retaining member 54 that secures the bar latch 20 to the dual top horizontal wire 22 opposite the bar latch hinge device 32.

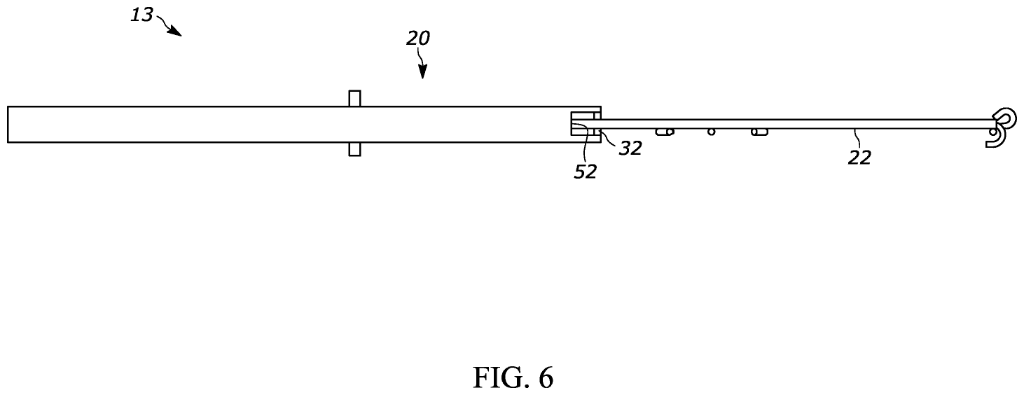

FIG. 6 illustrates a top view of the bar latch 20 engaging the bar latch hinge device 32, and the relative positioning of the hinge movement window 52 in the bar latch 20. In the embodiment shown, the bar latch 20 is pressed down onto the door 14 and door frame 9, and clips onto the bar latch hinge device 32. The hinge movement window 52 provides space for the bar latch 20 to be rotated up and away from the retaining member 54 without the aft end of the bar latch 20 colliding with the door frame 9 during rotation. In some embodiments, the range of motion of the bar latch 20 is limited by the depth of the hinge movement window 52. Accordingly, in some cases, the bar latch 20 may be rotated open into an obtuse angle with respect to the dual top horizontal wires 22 of the door frame 9 and rest in an open position, held there by an interaction between the hinge movement widow 52 and the dual top horizontal wires 22.

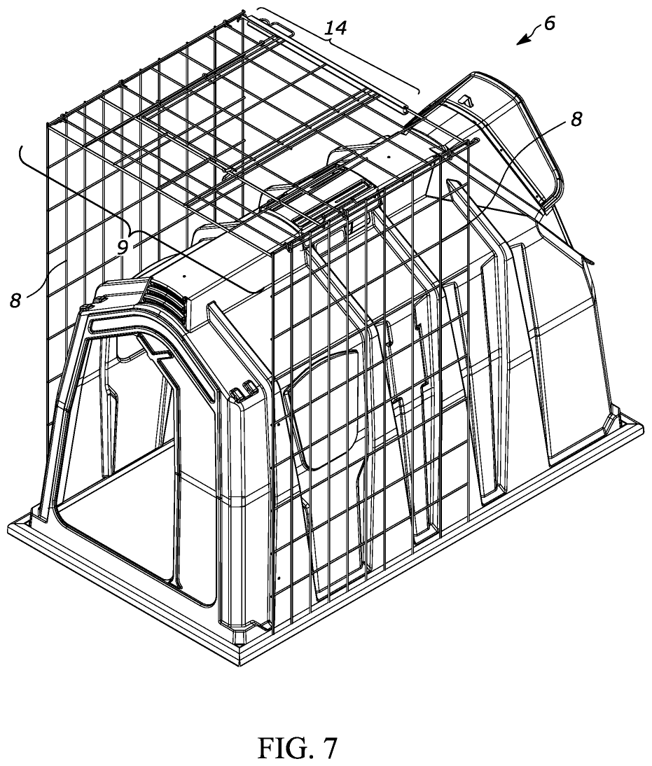

FIG. 7 illustrates the perimeter fence 6 formed by the door 14, door frame 9, and side panels 8 in a transport configuration, tilted into a canopy configuration over the hutch 2. In an operational configuration, the perimeter fence sits on a ground surface in front of the hutch 2, thereby forming a yard 4, as shown in FIG. 1. In the embodiment shown, the perimeter fence is tiltably connected to the hutch 2 at the rear corners 71 so that it is tiltable between the operational configuration shown in FIG. 1 and the transport configuration shown in FIG. 7. It should be noted that all of the linkages, hinges, latches, connections, etc. described herein are configured to hold together in both the operational configuration and the transport configuration.

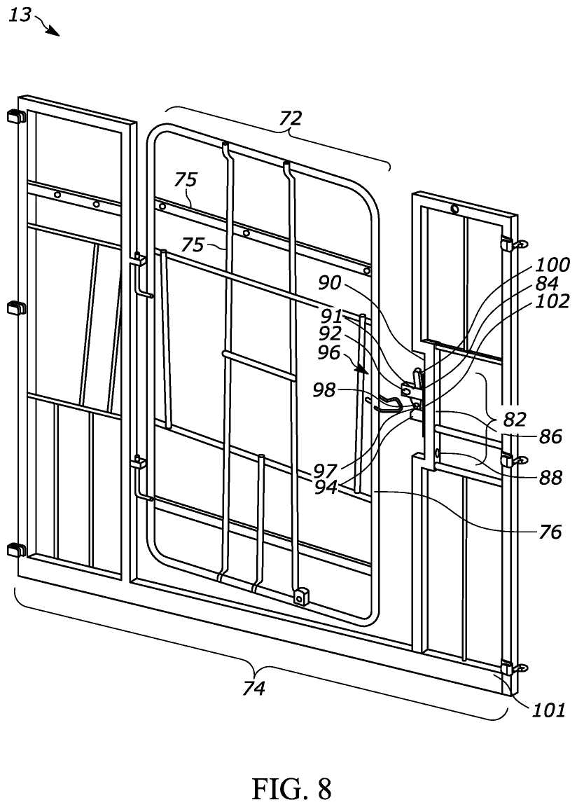

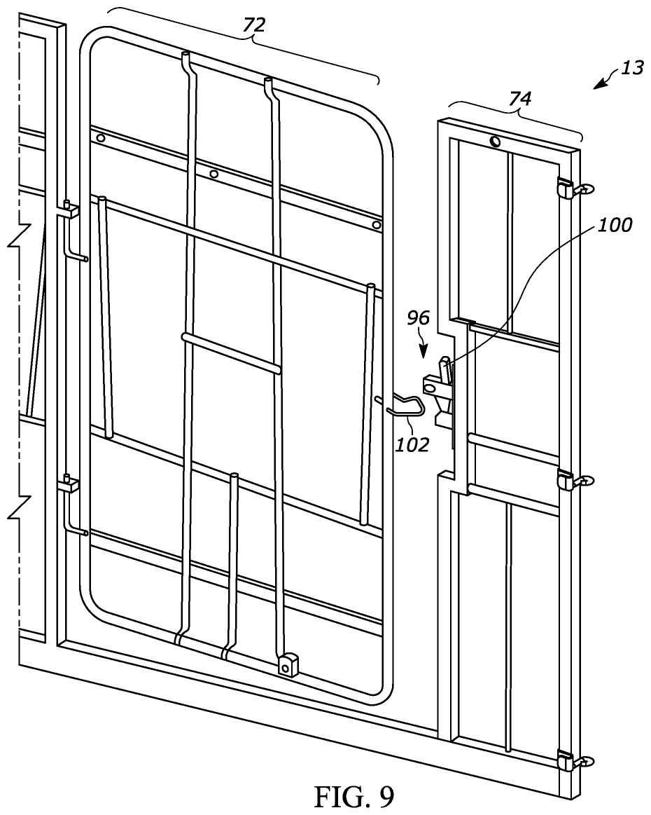

FIGS. 8-9 illustrate another embodiment of a front gate 13. In particular, FIGS. 8-9 show an opening and closing motion of a heavy duty door 72 within a heavy duty door frame 74. In FIG. 8, the heavy duty door 72 comprises a plurality of intersecting heavy duty bars 75 disposed within a circumferential member 76. Heavy duty hinge hooks 78, along one of the lateral extremities of the circumferential member 76, rotatably connect the heavy duty door 72 to the heavy duty door frame 74 by hooking into an a side threshold bar 80 of the heavy duty door frame 74, or an extension thereof. As with the wire door frame 14, the heavy duty door frame 74 may comprise purposeful accommodations for an animal to pass any portion of its body through (e.g. a hole for a baby calf to pass its head through and drink water from a reservoir exterior to the perimeter fence).

In FIG. 8, the heavy duty door 72 is in the closed position. A bidirectional gravity latch assembly 82 is disposed on one side of the heavy duty door frame 74. The bidirectional gravity latch assembly 82 comprises a mounting plate 84 including a back portion 86. The bidirectional gravity latch assembly 82 also includes at least one fastener hole 88 and a side portion 90 connected to the back portion 86 at an angle relative to the back portion 86. A latch bolt retaining portion 91 is connected to the back portion 86 and adjacent to the side portion 90, and includes a hinge-pin through-hole 92. A latch bolt seat 94 disposed below the latch bolt retaining portion 91, and a latch bolt is disposed in the latch bolt retaining portion 91. A latch bolt 96, retained in the latch bolt retaining portion 91 includes a hinging portion (not shown) having a hinge-pin through-hole (not shown), a seat abutting portion 97 having a lock accommodating through-hole 98, and a lever portion 100. A hinge pin is disposed in both the hinge-pin through-hole 92 of the latch bolt retaining portion 91 and the hinge-pin through-hole 92 of the latch bolt 96, such that the latch bolt 96 is rotatably retained in the latch bolt retaining portion 91 and movable between an opened position and a closed position. In the closed position, the seat abutting portion 97 sits on the latch bolt seat 94 and the lever is raised above the latch bolt retaining portion 91. It should also be noted that, in some embodiments, the heavy duty door frame 74 sits on a heavy duty door frame foot (not shown). The heavy duty door frame foot lifts the bottom threshold bar 101 of the heavy duty door frame off of a ground surface and helps to ensure that the heavy duty door has clearance to swing open and closed without colliding into a portion of the ground surface.

In the closed position, the seat abutting portion 97 of the latch bolt 96 sits on the latch bolt seat 94 of the bidirectional gravity latch assembly 82 and blocks a lateral movement of a door closure piece 102 when the heavy duty door 72 is rotated about the heavy duty hinge hooks 78, thereby preventing the heavy duty door 72 from opening. To open the door, the lever portion 100 of the latch bolt 96 is depressed, and the seat abutting portion 97 of the latch bolt lifts off of the latch bolt seat 94 of the latch bolt assembly. In the embodiment shown in FIG. 9, the heavy duty door 72 is in an opened position and is rotated with respect to the heavy duty door frame 74. To close the door, the heavy duty door 72 merely needs to be rotated back into the closed position. In the embodiment shown, the shape and position of the door closure piece 102 ensures that the latch bolt 96 is lifted out of the way as the door closure piece 102 makes contact with it while the heavy duty door 72 closes. Once the heavy duty door 72 is in the closed position, the latch bolt 96 falls into the middle of the door closure piece 102 and blocks lateral movement of the heavy duty door 72 until the latch bolt 96 is lifted again.

The embodiment described above and illustrated in the figures are presented by way of example only and are not intended as a limitation upon the concepts and principles of the present invention. As such, it will be appreciated that various changes in the elements and their configuration and arrangement are possible without departing from the spirit and scope of the present invention. Various features and advantages of the invention are set forth in the following claims.

What is claimed is:

1. A bar latch comprising:
a top portion including and inner and outer surface;
a latch retaining aperture disposed in a fore end of the top portion and extending between the inner and outer surface;
a first side portion connected to the top portion at a first angle relative to the top portion, the first side portion including a first arm extending beyond an aft end of the top portion; and,
a second side portion connected to the top portion at a second angle relative to the top portion and substantially equal but opposite to the first angle, the second side portion including a second arm that extends beyond the aft end of the top portion,
wherein an inner surface of the first side portion, an inner surface of the second side portion, and the inner surface of the top portion collectively form a channel extending along the inner surface of the top portion, and
wherein the bar latch is configured to be rotatably coupled to a door frame, the bar latch rotatable relative to the door frame between an open and a closed position.

2. The bar latch of claim 1, wherein the channel is configured to sit atop and engage a first side of the door frame, a door, and a second side of the door frame.

3. The bar latch claim 2, wherein the latch retaining aperture is configured to engage and be retained by a retaining member on the second side of the door frame when the latch is in the closed position, and wherein the latch retaining aperture is configured disengage the retaining member when the latch is in the open position.

4. The bar latch of claim 1, wherein the first arm and the second arm are configured to engage a hinge on the first side of the door frame and allow the bar latch to rotate about the hinge.

5. The bar latch of claim 4, wherein the first and second side portions define a hinge movement window therebetween.

6. The bar latch of claim 5, wherein the hinge movement window enables the bar latch to rotate from a parallel angle with respect to the door frame to an obtuse angle with respect to the door frame.

7. The bar latch of claim 1, further comprising a handle connected to an outer surface of the top portion.

8. A gate and latch assembly comprising:
a door frame including dual top horizontal wires, a bottom edge, a first outermost vertical wire, a second outermost vertical wire opposite the first vertical wire, a first side threshold wire, a second side threshold wire, and a bottom threshold wire;
a door disposed between the first side threshold wire and the second side threshold wire, and above the bottom threshold wire, the door having one or more hinge hooks extending from a vertical wire of the door and engaging the first side threshold of the door frame; and
a bar latch rotatably supported on one of the dual top horizontal wires.

9. The gate and latch assembly of claim 8, wherein the bar latch is rotatable between an open position and a closed position, and wherein, when in the closed position, the bar latch is configured to engage both of dual top horizontal wires and a the top portion of the door.

10. The gate and latch assembly of claim 9, wherein the bar latch includes
a top portion,
a latch retaining aperture disposed in the top portion,
a first side portion connected to the top portion at a first angle relative to the top portion, the first side portion including a first arm that extends beyond an aft end of the top portion; and
a second side portion connected to the top portion at a second angle relative to the top portion and substantially equal but opposite to the first angle, the second side portion including a second arm that extends beyond the aft end of the top portion,
wherein an inner surface of the first side portion, an inner surface of the second side portion, and an inner surface of the top portion collectively form a channel extending along the inner surface of the top portion.

11. The gate and latch assembly of claim 8, further comprising a latch retaining device disposed on a second dual top edge of the dual top horizontal wires.

12. The gate and latch assembly of claim 8, further comprising a retaining member disposed on one of the dual top wires of the door frame.

13. The gate and latch assembly of claim 12, wherein the retaining member is snap fit into the aperture to maintain the bar latch in a closed position, wherein, when in the closed position, the bar latch is configured to engage both of dual top horizontal wires and a the top portion of the door.

14. The gate and latch assembly of claim 12, wherein the retaining member is a bent, hemispherical wire that is fixed at one end to one of the dual top horizontal wires of the door frame and a second end that is not fixed.

15. A bidirectional gravity latch assembly comprising:
a mounting plate comprising a back portion including at least one fastener hole and a side portion connected to the back portion at an angle relative to the back portion;
a latch bolt retaining portion connected to the back portion and adjacent to the side portion, the latch bolt retaining portion including a hinge-pin through-hole;
a latch bolt seat portion disposed below the latch bolt retaining portion;
a latch bolt disposed in the latch bolt retaining portion and including a hinging portion having a hinge-pin through-hole, a seat abutting portion, and a lever portion; and
a hinge pin disposed in both the hinge-pin through-hole of the latch bolt retaining portion and the hinge-pin through-hole of the latch bolt, such that the latch bolt is rotatably retained in the latch bolt retaining portion and is movable between an open and closed position.

16. The bidirectional gravity latch assembly of claim 15, wherein, when the latch bolt is in the closed position, the seat abutting portion sits on the latch bolt seat portion and the lever is disposed above the latch bolt retaining portion.

17. The bidirectional gravity latch assembly of claim 16, wherein the latch bolt blocks a lateral movement of a door closure piece when the latch bolt is in the closed position.

18. The bidirectional gravity latch assembly of claim 15, wherein, when the latch bolt is in the open position, the lever portion of the latch bolt is depressed and the seat abutting portion of the latch bolt is lifted off of the latch bolt seat.

19. The bidirectional gravity latch assembly of claim 16, wherein the latch bolt does not block a lateral movement of a door closure piece when the latch bolt is in the open position.

20. The bidirectional gravity latch assembly of claim 15, wherein the seat abutting portion includes a lock accommodating through-hole.
